(19) United States
(12) Patent Application Publication
(10) Pub. No.: US 2006/0237888 A1
(43) Pub. Date: Oct. 26, 2006

(54) Inflatable clamping systems and methods

(75) Inventors: Kurt A. Burton, Wildwood, MO (US); Mike P. Matlack, St. Charles, MO (US); John A. Baumann, St. Charles, MO (US)

Correspondence Address: LEE & HAYES, PLLC, 421 W. RIVERSIDE AVE., SUITE 500, SPOKANE, WA, 99201, US

(73) Assignee: The Boeing Company

(21) Appl. No.: 11/112,994

(22) Filed: Apr. 22, 2005

(51) Int. Cl. B23Q 3/08

(52) U.S. Cl. 269/22

(57) ABSTRACT

The present invention is directed to systems and methods for clamping along a workpiece. In one embodiment, a clamping system includes an elongated member adapted to be positioned across a workpiece, and an elongated bladder adapted to be positioned between the member and the workpiece. The bladder applies a clamping force to the workpiece when the bladder is inflated. In another aspect of the invention, the system includes a plurality of clamp supports, supporting clamp bars. A high temperature hose is positioned between the clamp bar and the workpiece. The hose applies a clamping force to the workpiece when the hose is inflated. In accordance with other aspects of the invention, a method of clamping includes bridging the skin and substructure with an elongated clamp support, and inflating an elongated bladder between the clamp support and the skin, thereby clamping the skin to the substructure.

### FIELD OF THE INVENTION

This invention relates generally to clamping and, more specifically, to clamping during manufacturing operations.

### BACKGROUND OF THE INVENTION

During manufacturing work such as machining, routing, cutting, and welding, the workpiece is often held by clamps when a manufacturing tool engages it. Such clamps include bar clamps, C-clamps, vices, and other clamping tools. In manufacturing operations where a tool engages the workpiece with some force, clamping at fixed or distant locations may not be sufficient to hold the workpiece in position. As the tool moves, the distance between the manufacturing tool and the applied clamp or clamps may increase.

More specifically, in friction stir welding, a process that joins metals by thermoplastic deformation and inter mixing, plunging the friction stir welding tool into a weld line of a workpiece and moving the tool along the weld line can push the parts of the workpiece being welded away from the underlying structure, or away from each other. According, there is an unmet need for clamping systems that more securely engage a workpiece along a working area for a manufacturing tool.

### SUMMARY

The present invention is directed toward systems and methods for clamping along a workpiece. In one embodiment, a clamping system includes an elongated member adapted to be positioned across a workpiece, and an elongated bladder adapted to be positioned between the member and the workpiece. The bladder applies a clamping force to the workpiece when the bladder is inflated. In another aspect of the invention, the system includes a plurality of clamp supports, supporting clamp bars that bridge a workpiece. A high temperature hose bladder is positioned between the clamp bar and the workpiece. The hose bladder applies a clamping force to the workpiece when the hose is inflated. In accordance with other aspects of the invention, a method of clamping includes positioning a skin over a substructure, bridging the skin and substructure with an elongated clamp support, and inflating an elongated bladder between the clamp support and the skin, thereby clamping the skin to the substructure for welding or other manufacturing processes.

### BRIEF DESCRIPTION OF THE DRAWINGS

Preferred and alternate embodiments of the present invention are described in detail below with reference to the following drawings.

FIG. 1 is an exploded isometric view of an exemplary clamp system bridging a workpiece in accordance with an embodiment of the present invention;

FIG. 2 is an isometric view of an exemplary clamp system engaged with a workpiece in accordance with an embodiment of the present invention;

FIG. 3A is an isometric view and cross-section of exemplary clamp bars engaged with a workpiece in accordance with the embodiment of the present invention;

FIG. 3B is a cross-section of exemplary clamps engaging a workpiece during friction stir welding in accordance with an embodiment of the present invention;

FIG. 4 is a side view of an exemplary clamping system with clamp bars in accordance with an embodiment of the present invention;

FIG. 5 is a cross-section of exemplary clamp bars bridging a workpiece in accordance with an embodiment of the present invention; and

FIG. 6 is a flow chart of an exemplary method of clamping in accordance of another embodiment of the present invention.

### DETAILED DESCRIPTION

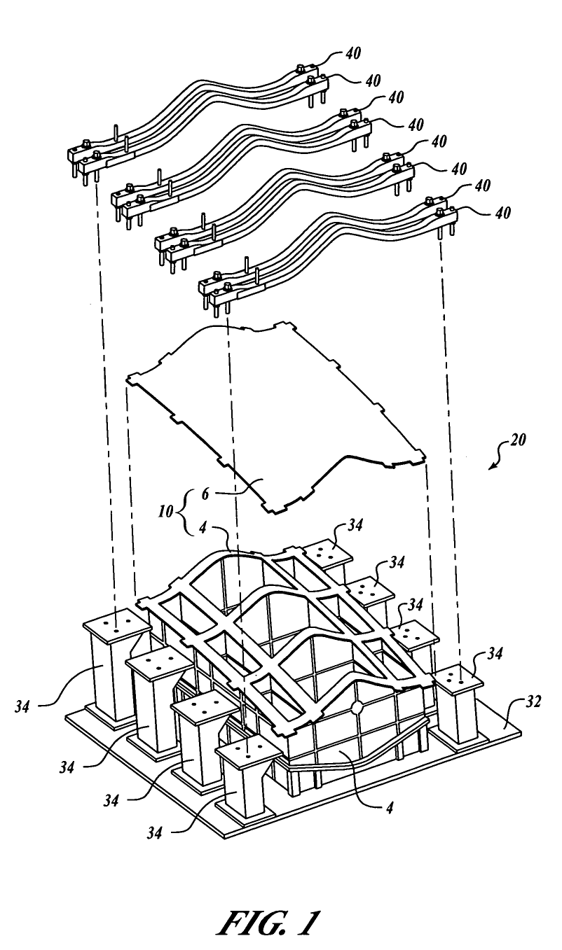

The present invention relates to systems and methods for clamping. Many specific details of certain embodiments of the invention are set forth in the following description and in FIGS. 1-6 to provide a thorough understanding of such embodiments. One skilled in the art, however, will understand that the present invention may have additional embodiments, or that the present invention may be practiced without one or more of the details described in the following description.

FIG. 1 shows an exemplary clamping system 20 in exploded view over a workpiece 10 including a substructure 4 and a skin 6. The skin 6 is to be attached to the substructure 4. The substructure 4 is positioned on a base 32 that supports the substructure 4 during a manufacturing process such as machining, routing, cutting, or welding.

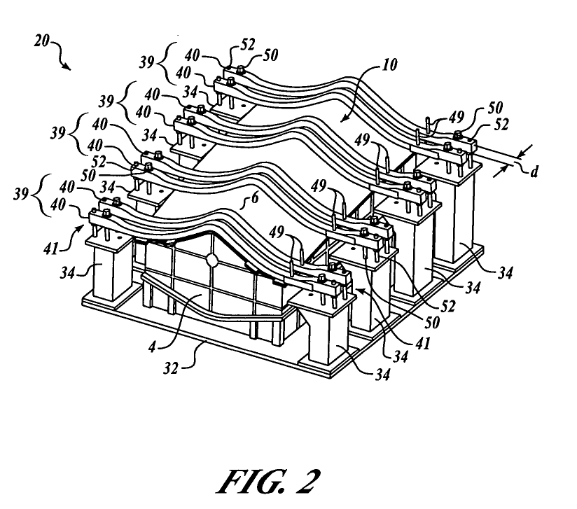

In this exemplary embodiment, the clamping system 20 includes a plurality of elongated bladder clamps 40 that partially or substantially bridge the skin 6 and substructure 4. The clamps 40 are supported at their ends 41 (FIG. 2) by clamp supports 34. The clamp supports 34 holding the clamps 40 in position bridging across the workpiece 10.

FIG. 2 shows the clamping system 20 of FIG. 1 with the bladder clamps 40 mounted to the clamp supports 34. In this embodiment the clamps 40 completely bridge the workpiece 10. The clamp supports 34 are, in this exemplary embodiment, steel beams mounted vertically to a base 32. The supports 34 are in pairs on opposite sides of the workpiece 10.

In this embodiment, the bladder clamps 40 are suitably curved to follow a curved contour in the underlying workpiece 10, permitting the skin 6 to be held tightly to the substructure 4 for manufacturing operations across the workpiece 10. When the clamps 40 are activated, as described below, a clamping force is applied in a line across the surface of the workpiece 10. By way of example, without limitation, the clamps 40 may bridge the workpiece 10 in pairs 39 with a distance d between the clamps 40. A manufacturing tool may be inserted between the members of the pairs 39 to engage the workpiece 10. The tool may also be moved across the workpiece 10. Working in pairs 39, the workpiece 10 is securely clamped on both sides of the manufacturing tool, in close proximity to the manufacturing tool (not shown) across any desired portion of the span of the workpiece 10.

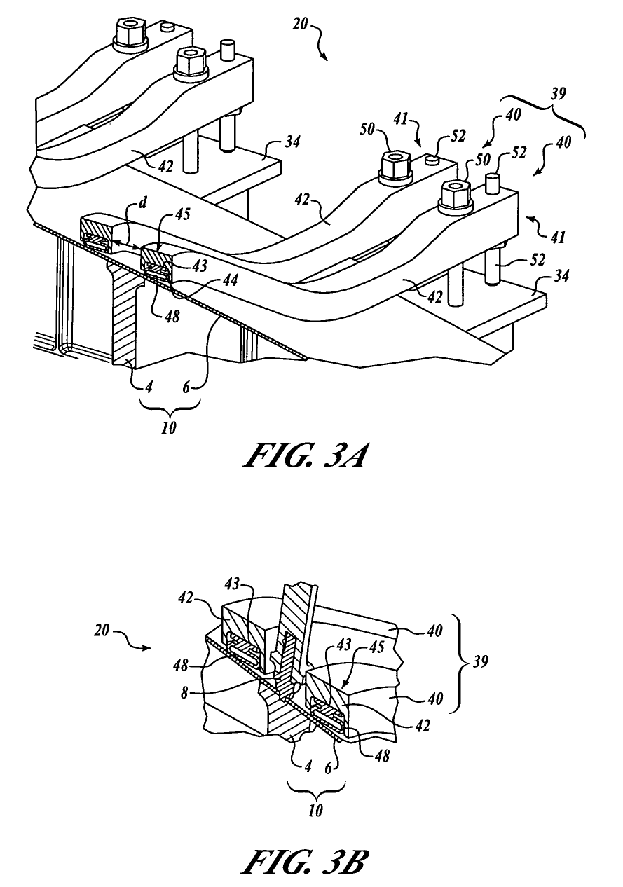

The bladder clamps 40 include inflation tubes 49 for inflating inflatable bladders (not shown) on the underside of the clamps 40 as described below with reference to FIGS. 3A and 3B. The clamps 40 at their ends 41 are attached to the clamp supports 34 with bolts 50 threadedly connected to the tops of the clamp supports 34. By way of example, but not limitation, the bolts 50 suitably may be ½″ steel bolts for friction stir welding applications of the system 20. Stops 52 at the ends 41 of the clamps 40 hold the clamp ends 41 a desired distance above the clamp supports 34 when the clamps 40 are bolted to the clamp supports. The stops 52 aid in the clamps 40 being removably positioned over the workpiece 10 at a desired distance from the workpiece. The clamps 40 may be bolted to the clamp supports 34 with the bolts 50 tightened until the adjustable stops 52 engage the clamp supports 34, stopping further motion of the clamps 40 toward the workpiece. In this example embodiment, the stops 52 are suitably steel pins or threaded rod projecting downward from the clamps 40 towards the clamp supports 34.

FIG. 3A is an isometric cutaway view with the bladder clamps 40 of FIGS. 1 and 2 positioned over the workpiece 10. The clamps 40 hold a skin 6 secure to an underlying substructure 4 in the workpiece 10. The clamping system 20 in the embodiment shown in FIGS. 1 and 2 includes a plurality of pairs 39 of bladder clamps 40 bridging the workpiece 10. In FIG. 3A, the ends 41 of one pair 39 of clamps are shown attached to the clamp supports 34. As described above, bolts 50 hold the clamps 40 to the clamp supports 34 with a stop 52 holding the ends 40 a desired distance above the clamp supports 34.

In this embodiment, the clamps 40 include clamp bars 42 that bridge the workpiece 10. The clamp bars 42, by way of example, but not limitation, may be machined bars of ASTM-A36 steel curved to match the underlying contour of the workpiece 10. In alternate embodiments, the clamp bars 42 may be formed from any suitably rigid material. The clamp bars 42 include a distal surface 45 facing away from the workpiece, and a proximal surface 44 facing the workpiece 10. In this embodiment, a proximal (or lower) surface 44 of each bar 42 has a channel (or recess) 43 formed therein. The channel 43 may be machined, cast, or otherwise formed in the proximal surface 44 of the clamp bar 42. The channel 43 provides a space for holding an elongated inflatable bladder (or member) 48. The bladder 48 is inflated to apply clamping pressure to the workpiece 10 under each clamp bar 42 across the entire surface of the workpiece, or alternately, across a desired portion of the surface of the workpiece 10. In one particular embodiment, the bladder 48 is initially contained within the channel 43, and as the bladder 48 is inflated it expands outwardly from within the channel 43 to exert a clamping force on the workpiece 10. Subsequently, when it is deflated, the bladder 48 retracts back into the channel 43, where it is at least partially protected from damage or wear.

In one particular embodiment, the clamp bars 42 are approximately 1.5 inches in width and 1 inch in thickness. The channel 43 formed in the proximal surface 44 of the bar 42 may have a “C” cross-sectional shape, and may have a width of approximately 1.25 inches and a depth of approximately 1.0 inches. The bladder 48 partially nests up within the channel 43 within the proximal surface of the bar 42, and extends outward from the bar when the bladder 48 is inflated.

In one particular embodiment, the elongated bladder 48 is a silicon hose with NOMEX fiber manufactured by Presray Pneuma-seal of Pawling Engineered Products. The silicon bladder with NOMEX fiber retains approximately 80% of its strength at 400° Fahrenheit, permitting high temperature manufacturing operations to be undertaken on the workpiece 10 in close proximity to the clamps 40. By way of example, but not limitation, in friction stir welding applications of an approximately one-eighth inch aluminum skin to an underlying substructure, the bladders are suitably inflated between 10 and 80 psi, and the clamp bars 42 of each pair 39 of clamp bars 40 are positioned approximately 1.25 inches apart. A friction stir welding tool may then engage the workpiece 10 between the clamps 40 with the bladders 48 maintaining clamping pressure on the workpiece 10 despite the heat generated by the friction stir welding tool.

FIG. 3B is a detail of the system 20 of FIG. 3A showing a friction stir welding tool 8 engaging a workpiece 10 between a pair 39 of clamps 40. Bladders 48 within channels 43 of the clamp bars 42 apply a clamping pressure on alternate sides of the tool 8. It will be appreciated that the elongated clamps 40 permit the friction stir welding tool 8 to make a linear weld across the workpiece, following the contour of the workpiece 10 with clamping supplied by the clamps 40 along both sides of the weld substantially across the entire workpiece 10.

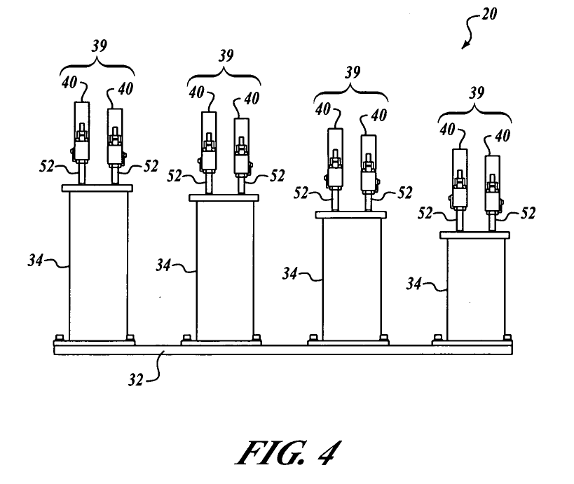

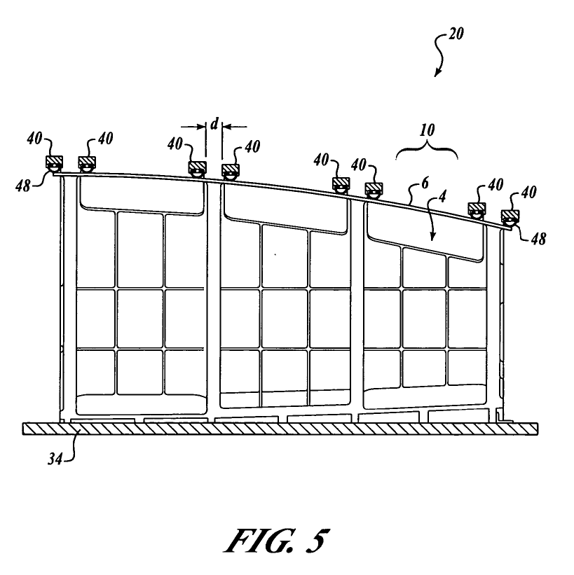

FIGS. 4 and 5 are side elevational and side cross-sectional views of a clamping system 20 of the present invention, respectively. The system 20 includes four pairs 39 of clamps 40 bridging the workpiece 10. Each pair 39 of clamps 40 is supported by a clamp support 34. The clamp supports 34 are mounted to a base 32. At their ends, the clamps 40 are held a desired distance off the upper surface of the clamp supports 34 by stops 52 with the clamps 40 then bridging the workpiece (not shown) a desired distance off the workpiece. As shown in FIG. 5, the clamp supports 34 and stops 52 hold the bladder clamps 40, a desired distance above the upper surface of the workpiece 10 with the pairs of clamps 40 separated by distance d. By way of example, but not limitation, the clamps 40 suitably may be positioned 0.1 inch above the workpiece prior to inflation of the bladders 48 in the clamps.

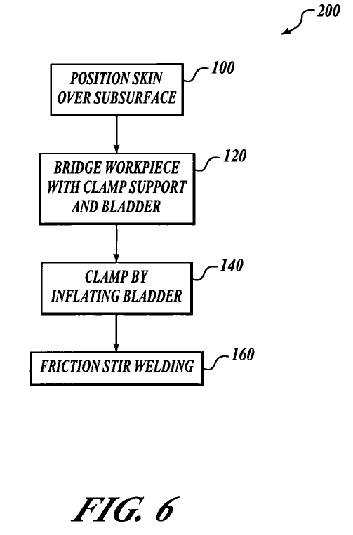

FIG. 6 is a flow chart of an exemplary method of clamping 200 in accordance with another embodiment of the present invention. At a block 100, a skin is positioned over a substructure. At a block 120, a workpiece of the skin and substructure is bridged with a clamp support and bladder. At a block 140, the workpiece is clamped by inflating the bladder. It will be appreciated that the bladder may be preinflated and then pressed against the workpiece. At a block 160, a manufacturing operation is performed on the workpiece 10, in this example, by friction stir welding proximate to the bladder.

While preferred and alternate embodiments of the invention have been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. A clamping system for securing a work piece, comprising:
a first elongated member adapted to be positioned across the workpiece; and
a first elongated bladder adapted to be positioned between the first elongated member and the workpiece, the first bladder adapted to apply a clamping force to the workpiece when the first bladder is inflated.

2. The clamping system of claim 1, wherein the bladder includes a hose.

3. The clamping system of claim 2, wherein the hose includes silicone and reinforcing fibers.

4. The clamping system of claim 1, wherein the elongated member includes a bar.

5. The clamping system of claim 1, wherein at least a portion of the bar is curved.

6. The clamping system of claim 1, wherein the first elongated member defines an elongated channel adapted to partially confine the bladder.

7. The clamping system of claim 1, further comprising:
a second elongated member adapted to be positioned across the workpiece parallel and proximate to the first elongated member; and
a second elongated bladder adapted to be positioned between the second elongated member and the workpiece, the second bladder adapted to apply a clamping force to the workpiece when the second bladder is inflated.

8. The clamping system of claim 7, wherein the second elongated member defines a channel adapted to partially confine the bladder.

9. The clamping system of claim 1, further comprising a base operatively coupled to the first elongated member and adapted to receive and support the workpiece, the workpiece being clamped between the base and the first elongated member when the first bladder is inflated.

10. A clamping system, comprising:
a plurality of pairs of elongated bars, each elongated bar having first and second ends and being adapted to at least partially bridge a workpiece, each pair of bars being separated by a width sufficient to pass a manufacturing tool; and
a plurality of inflatable hoses, each hose positioned along a side of a corresponding one of the elongated bars that is positioned proximate to the workpiece when the elongated bar is positioned to at least partially bridge the workpiece, each inflatable hose being adapted to apply a clamping force to the workpiece when the hoses are inflated.

11. The clamping system of claim 10, wherein the side of the elongated bar proximate to the workpiece includes a channel, the hose being at least partially disposed within the channel.

12. The clamping system of claim 10, wherein the hoses are adapted to be inflated by air.

13. The clamping system of claim 10, wherein the hoses include silicone and reinforcing fibers.

14. The clamping system of claim 10, further comprising a base operatively coupled to the elongated bars and adapted to receive and support the workpiece, the workpiece being clamped between the base and the elongated bars when the hoses are inflated.

15. The clamping system of claim 14, wherein the base includes a plurality of pairs of clamp supports, wherein each of a member of the pairs of clamp supports is adapted to attach to and support at least one of the first and second ends.

16. The clamping system of claim 15, wherein the member is adapted to threadedly attach to at least one of the first and second ends.

17. The clamping system of claim 16, wherein being adapted to threadedly attach includes an adjustable stop adapted to hold the at least one of the first and second ends a predetermined distance from the member.

18. A method for clamping a workpiece during a manufacturing operation, comprising:
bridging a portion of the workpiece with an elongated bar, the bar including an elongated bladder on a side of the elongated bar proximate the workpiece; and;
inflating the elongated bladder.

19. The method of claim 18, wherein bridging a portion of the workpiece includes bridging a portion of the workpiece with a bar having a recess formed therein, the elongated bladder being at least partially disposed within the recess, and wherein inflating the elongated bladder includes inflating an elongated member such that the elongated member expands outwardly from the recess.

20. The method of claim 18, further comprising at least partially supporting the workpiece on a base, and wherein inflating the elongated member includes clamping the workpiece between the elongated bar and the base.
